(19) United States
(12) Patent Application Publication
(10) Pub. No.: US 2017/0227070 A1
(43) Pub. Date: Aug. 10, 2017

(54) MAGNETIC CLUTCH

(71) Applicant: Vastech Holdings Ltd., London (GB)

(72) Inventors: Alexander MOSTOVOY, Ashkelon (IL); Victor SHLAKHETSKI, Ashkelon (IL)

(21) Appl. No.: 15/124,089

(22) PCT Filed: Mar. 13, 2014
(86) PCT No.: PCT/IL2014/050274

§ 371 Date: Sep. 7, 2016

(51) Int. Cl. F16D 27/01; H02K 49/10

(52) U.S. Cl. CPC F16D 27/01; H02K 49/106

(57) ABSTRACT

A magnetic clutch comprises: a) two concentric rings; b) an equal number of magnets connected to the inner ring and to the outer ring; and c) an opposite orientation of the poles of each couple of facing magnets, wherein one magnet is placed on the inner ring, and its facing magnet is placed on the outer ring; wherein the first of said two concentric rings is rotatable around an axis by the application of a force not applied by the second ring, and wherein when said first concentric ring rotates, the second ring rotates as well by the action of magnetic forces.

### FIELD OF THE INVENTION

The present invention relates to a magnetic clutch architecture. More particularly, the invention relates to a magnetic clutch designed to control the movement of two rotating rings, without using direct or indirect mechanical connection between the rings, such as gear, wheels, strips, or any other mechanical components.

### BACKGROUND OF THE INVENTION

In many common systems, the connection between different parts of the system is performed by mechanical components. A significant disadvantage of using such connecting parts is the energy loss, caused by friction. Another disadvantage caused by friction is the wear of the connecting surfaces of the parts. As the speed and force between the parts increase, so does the friction and therefore the damage to their surfaces, until they often can no longer function properly.

In systems operating at high speeds the friction and its outcomes are substantial, resulting in the need for many maintenance services and frequent change of parts, which require a great investment of both time and money.

It is an object of the present invention to provide a device and method that overcome the drawbacks of the prior art.

It is another object of the invention to provide a frictionless clutch system.

It is yet a further object of the invention to provide an efficient clutch system that can be used in a variety of apparatus.

Other objects and advantages of the invention will become apparent as the description proceeds.

### SUMMARY OF THE INVENTION

The apparatus of the invention comprises:
a) two concentric rings;
b) an equal number of magnets connected to the inner ring and to the outer ring; and
c) an opposite orientation of the poles of each couple of facing magnets, wherein one magnet is placed on the inner ring, and its facing magnet is placed on the outer ring;
wherein the first of said two concentric rings is rotatable around an axis by the application of a force not applied by the second ring, and wherein when said first concentric ring rotates, the second ring rotates as well by the action of magnetic forces.

In one embodiment of the invention the rings are flat ring-shaped plates. According to another embodiment of the invention each couple of facing magnets are of the same size. In a further embodiment of the invention the magnetic strengths of two facing magnets are essentially the same. According to another embodiment of the invention each of the magnets in the inner ring has a facing magnet in the outer ring.

The connecting means are suitable to connect one of the rings to an external system and, according to an embodiment of the invention, the ring which is not connected to the external system is driven by the rotation of the ring that is connected to the external system.

Typically, the driven ring is forced to move because of the magnetic force between two coupled magnets and in an embodiment of the invention the distances between the components of the apparatus are consistent with the desired forces.

The distance between two adjacent magnets on the ring may not be the same as the distance between two other adjacent magnets on the same ring.

A method for coupling two rings, comprising providing two concentric rings, an equal number of magnets connected to the inner ring and to the outer ring, and an opposite orientation of the poles of each couple of facing magnets, wherein one magnet is placed on the inner ring, and its facing magnet is placed on the outer ring, wherein the first of said two concentric rings is rotatable around an axis by the application of a force not applied by the second ring, and wherein when said first concentric ring rotates, the second ring rotates as well by the action of magnetic forces.

### BRIEF DESCRIPTION OF THE DRAWINGS

In the drawings:

FIG. 1 shows two concentric rings, provided with magnets, according to one embodiment of the invention, in a static state;

FIG. 2 shows the two rings of FIG. 1 in a dynamic state;

FIG. 3 shows the measurements of the force on a single couple of magnets mounted at distance d from each other and shifted linearly;

FIG. 4 shows the measurements of the force in a demo system, according to another embodiment of the invention;

FIG. 5 shows a schematic setup of two magnets, according to another embodiment of the invention;

FIG. 6 shows solenoids illustrated as consisting of a collection of infinitesimal current loops, stacked one on top of the other; and

FIG. 7 shows two loops of infinitesimal thickness, each one belonging to a magnet.

### DETAILED DESCRIPTION OF THE INVENTION

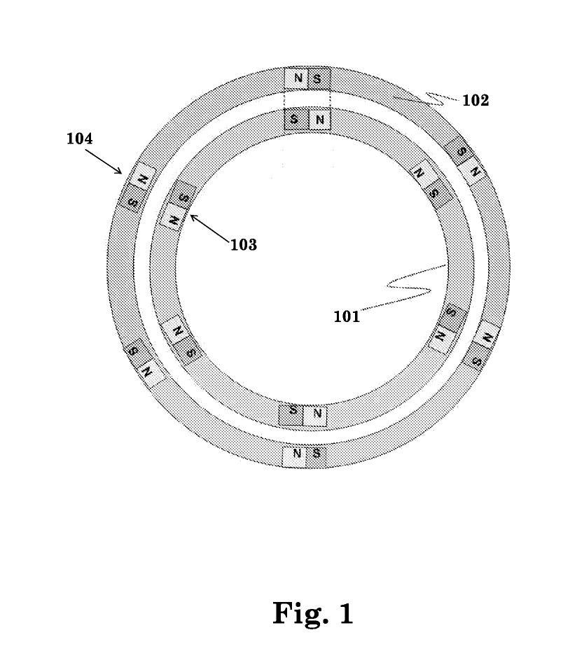

FIG. 1 shows two concentric rotating rings 101 and 102 at rest. One of them, for instance, the inner one (the “driving” ring) 101, is connected to a mechanical device that generates motion and the other, for instance, the outer one 102, is connected to a mechanical load and provides the power for it. The purposes of the rings 101 and 102 are interchangeable.

Magnets with their S-N axes oriented tangentially to the circumference, are mechanically fixed on both the inner ring 101 and the outer ring 102 in equal numbers. At rest, each one of the magnets 104 located on the outer ring 102, is facing a corresponding magnet 103 located on the inner ring 101. The S-N axis orientation of each magnet 104 on the outer ring 102 is opposite to the S-N axis orientation of the corresponding (facing) magnet 103 on the inner ring 101. The position and the orientation of each magnet on one ring can be arbitrary, while the orientation of the corresponding magnet on the other ring should be opposite. Therefore the magnets on the inner ring 103 are in opposite orientations from the magnets on the outer ring 104.

FIG. 1 shows an exemplary implementation of the clutch, according to one embodiment of the invention, wherein all the magnets 103 and 104 are equally spaced, with alternating orientation. However, as hereinbefore explained, both the position and the orientation of each magnet on one ring may be arbitrarily chosen so to be optimized for a specific application. It should be emphasized that there is no physical connection between the inner ring 101 and the outer ring 102. For reasons that will be explain later on in this description, based on the laws of magnetostatics, the relative position of the inner ring 101 with respect to the outer ring 102, depends on the state of the system—if the system is in a static state or a dynamic state, as will be further described.

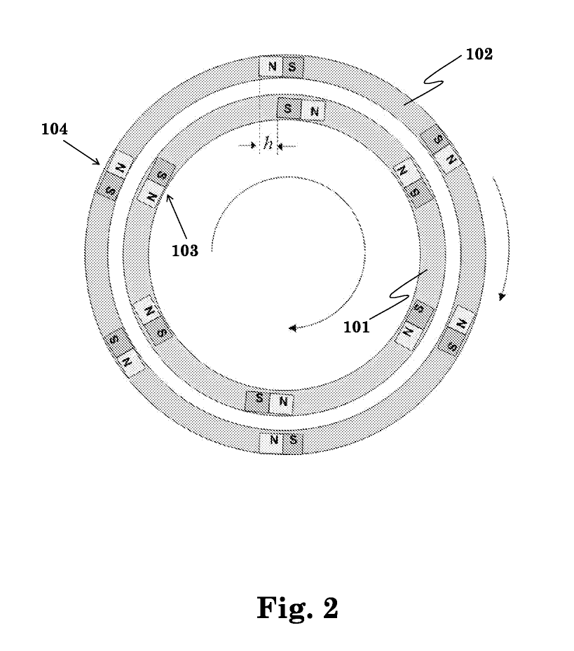

In a static state—when the system is at rest, each magnet 104 on the outer ring 102 is exactly aligned in front of the corresponding magnet 103 on the inner ring 101. As shown in FIG. 2, in a dynamic state—when one ring is driven into rotation, while the other one is connected to a load (not completely free to move), the relative position of each magnet on the driving ring with respect to the corresponding magnet on the load ring, will change and will stabilize to a new state.

The corresponding magnets 103 and 104 will no longer be perfectly aligned. The relative position of the magnets 103 and 104 will shift in a quasi-linear fashion tangentially to the circumference of the rings 101 and 102. The magnets will reach an offset h, as shown in FIG. 2, and will stabilize there. The offset h will depend on the opposing force exercised by the load. As the description proceeds, it will be seen that under proper conditions h will increase directly proportionally to the force needed to make the load ring rotate along with the driving ring.

As will be shown hereinafter, in the range of interest the offset h is roughly directly proportional to the force transfer, and as long as h is not too large, the driving ring will be able to “pull along” the load ring, without the occurrence of any physical contact between the two ring 101 and 102. When the size of h approaches the width of the gap between the magnets 103 and 104, the force transferred drops. The maximal force that the driving ring will be able to apply to the load ring, will depend on the strength and on the geometry of the permanent magnets, on the number of magnets, as well as on the gap between the two rings 101 and 102.

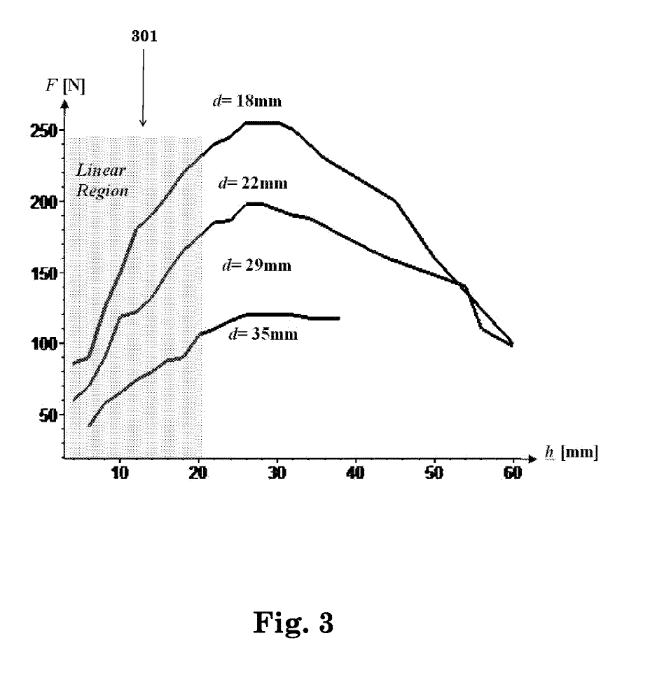

FIG. 3 shows the measurements of the force on a single couple of magnets mounted at distance d from each other and shifted linearly. The shaded area 301 shows the range for which the pulling force between the magnets 103 and 104 is roughly proportional to the offset h of FIG. 2.

To illustrate the order of magnitude of the forces involved, two magnets with front-to-front separation of 29 mm can provide roughly a maximal force transfer of 140N (about 14 Kg) in a direction tangential to the rings. In a demo system built according to the invention 8 magnets were provided with face-to-face separation of about 30 mm. The demo system is capable to apply a force of 140×8=1120N (about 112 Kg).

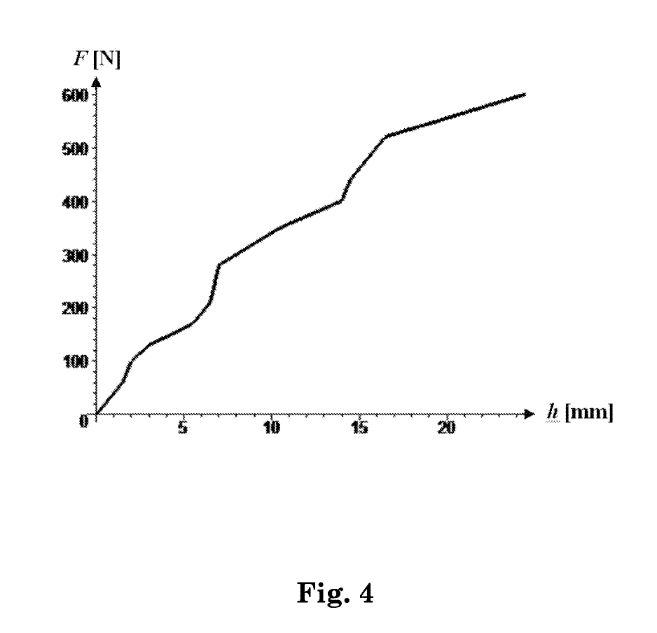

FIG. 4 shows measurements carried out on a demo system. The experiment was carried out not to achieve and measure the maximal power transfer, however, it showed force transfer measurements of the order of 600N, which is in good agreement with the order of magnitude of the maximal possible force (1120N) predicted by the measurements on one couple of magnets. Also it shows that the total force is proportional to the relative offset.

Magnetostatic computations are among the most difficult and complex tasks to be carried out analytically, and even when a closed-form analytical expression can be found, the resulting formulas are often too complex to provide a clear understanding of the phenomena. Moreover, most often one can only perform computerized simulations obtained by numerically solving the field equations. Numerical solutions, however, although precise for a specific setup, do not provide an insight to the general behavior of the system.

Fortunately, in the specific case under consideration, general conclusions can be drawn by means of a relatively simple mathematical analysis. This is made possible because in the system under consideration the magnets are free to move only along a direction tangential to their S-N axis, and they are fixed in all other directions. Therefore, it is only needed to compute the component of the force in a direction parallel to the S-N axes of the magnets, which results in major mathematical simplifications that allow us to draw conclusion regarding general system features, without the need of actually solving the complex three-dimensional integrals involved.

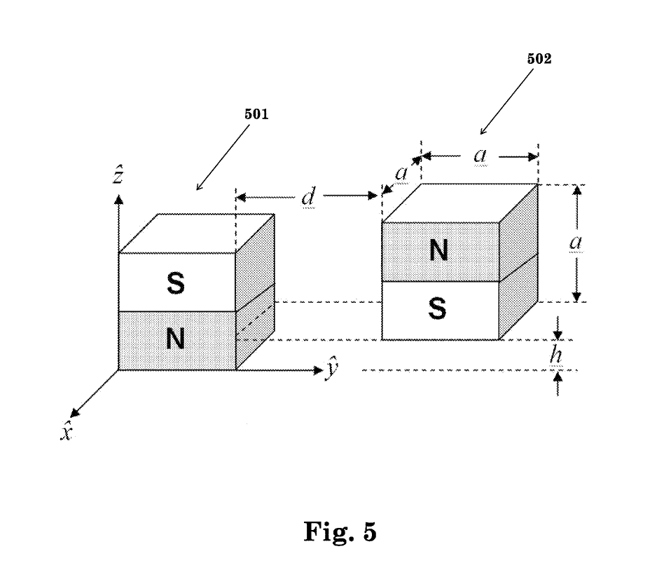

FIG. 5 shows a schematic setup of two magnets, according to another embodiment of the invention, on which the analysis relies. \hat{x}, ŷ and \hat{z} are mutually perpendicular unit vectors. Two cubic magnets 501 and 502 are positioned so that their S-N axes are parallel to direction \hat{z}. Their S-N orientation is opposite, and they are displaced with an offset h in direction \hat{z}. The magnets 501 and 502 are assumed cubic, for the purpose of this exemplary analysis, however the general conclusions hold true for other shapes as well.

According to the setup of FIG. 5, as long as the offset h is small relatively to the physical dimension of the gap between the magnets 501 and 502, the component of the force acting on either magnet 501 and 502 in the direction \hat{z}, is directly proportional to the offset h. The size of h is relatively small, roughly when the offset h is less than ⅓ of the distance d between the magnets 501 and 502. As the offset h becomes larger than that, the force reaches a maximal value, and then decreases with increasing h.

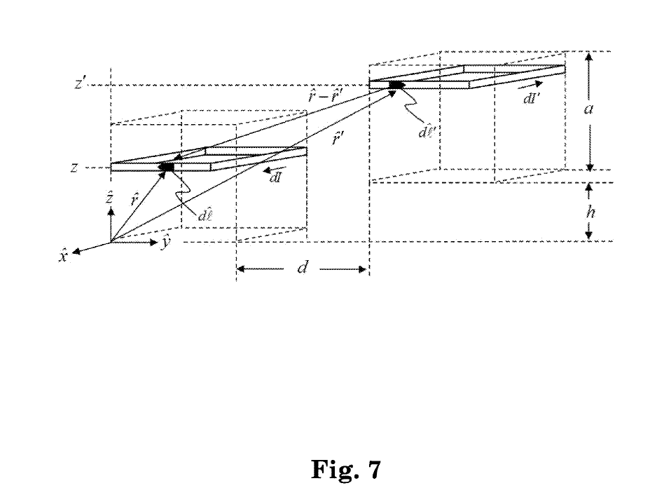

As a first step, by using the Amperian model, a permanent magnet with magnetization M in the direction \hat{z}, may be modeled in the form of a uniform surface current density Jₛ flowing on the surface of the magnet in direction perpendicular to \hat{z}. M is the net magnetic dipole moment per unit volume, and Jₛ is the equivalent surface current per unit length. Therefore we may replace each magnet 501 and 502 in FIG. 5 by the equivalent “solenoids”, as shown in FIG. 7, with equal currents in opposite directions.

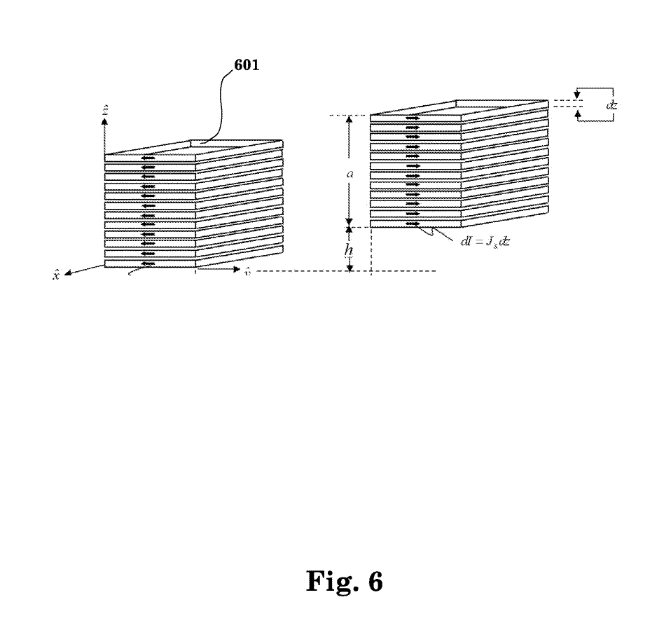

Each solenoid 601 in FIG. 6 can be represented as consisting of a collection of infinitesimal current loops, stacked one on top of the other, carrying currents of amplitudes dI=Jₛdz and dI′=Jₛdz′, flowing in the \hat{x}ŷ plane in opposite directions. Let us consider now, two loops of infinitesimal thickness, each one belonging to one of the magnets, as shown in FIG. 7.

The force caused on the left-side loop L located at vertical position z by the right-side loop L′ located at vertical position z′, is directly derived from Ampere's law of force, and is given by the expression

$${\vec{F}}_{{p}^{′} p} ( z , {z}^{′} ) = - \frac{μ {dI}^{′} dI}{4 π} {\int }_{L} {\int }_{{L}^{′}} ( \hat{d l} \cdot {\hat{d l}}^{′} ) \frac{{\hat{r}}_{{p}^{′} p}}{{\vert \hat{r} - {\hat{r}}^{′} \vert}^{2}} = - \frac{μ {dI}^{′} dI}{4 π} {\int }_{L} {\int }_{{L}^{′}} ( \hat{d l} \cdot {\hat{d l}}^{′} ) \frac{\hat{r} - {\hat{r}}^{′}}{{\vert \hat{r} - {\hat{r}}^{′} \vert}^{3}}$$

$$where$$

$${\hat{r}}_{{p}^{′} p} = \frac{\hat{r} - {\hat{r}}^{′}}{\vert \hat{r} - {\hat{r}}^{′} \vert} , \hat{r} - {\hat{r}}^{′} = ( x - {x}^{′} ) \hat{x} + ( y - {y}^{′} ) \hat{y} + ( z - {z}^{′} ) \hat{z} , \\ \vert \hat{r} - {\hat{r}}^{′} \vert \sqrt{{( x - {x}^{′} )}^{2} + {( y - {y}^{′} )}^{2} + {( z - {z}^{′} )}^{2}}$$

and d\hat{l} and d\hat{l}′ are infinitesimal lengths in the direction of the current flow in the corresponding loops, and therefore they lie in the \hat{x}ŷ plane.

Now, referring to FIG. 7 the following preliminary remarks should be noted:

1. We know that |y−y′|≧d and we denote R_{\hat{x}ŷ}≡\sqrt{(x−x′)²+(y−y′)²}. It follows that R_{\hat{x}ŷ}≧d. R_{\hat{x}ŷ}=R_{\hat{x}ŷ}(x,x′,y,y′) is independent from z and z′, and we may write |\hat{r}−\hat{r}′={square root over (R_{\hat{x}ŷ}²(z−z′)²)}.

2. In the present setting, d is comparable to the size of the magnet, and we assume offsets small enough so that h²<<d² (for instance h²<<d²).

3. Since we are interested only in the force in the \hat{z} direction, the only relevant component of \hat{r}−\hat{r}′ in the numerator of the integrand, is the one in direction \hat{z}. All other forces are of no interest, since the magnets cannot move in other directions. Thus, in order to compute the force acting on the magnets in z direction, we may replace \hat{r}−\hat{r}′ in the numerator of the integrand by (z−z′)\hat{z}.

4. d\hat{l} and d\hat{l}′ are incremental vectors in the \hat{x}ŷ plane. More precisely, in the present setting of square magnets, the scalar product (d\hat{l}·d\hat{l}′) is either ±dxdx′ or ±dydy′. Therefore z and z′ are constant with respect to the integration variables when integrating over the path of the loops. Moreover, if dx, dx′ have opposite signs, their direction of integration is opposite too, and therefore, the limit of the corresponding integrals are reversed, and similarly for dy, dy′. The outcome is that the sign of the integral for all the various sub-integration ranges defined by (d\hat{l}·d\hat{l}′) remains unchanged. Therefore the sign value of the double integral over the loop paths, is the same as the sign of the integrand.

With the above understanding, the force ΔF_{z} in direction \hat{z} acting on the current loop L because of the current loop L′, is the result of the following integral:

$$Δ {F}_{\hat{z}} = - \frac{μ {J}_{s}^{2} {dz}^{′} dz}{4 π} {\int }_{L} {\int }_{{L}^{′}} \frac{( \hat{d l} \cdot {\hat{d l}}^{′} ) ( z - {z}^{′} )}{{[ {R}_{\hat{x} \hat{y}}^{2} + {( z - {z}^{′} )}^{2} ]}^{3 / 2}} , \\ {R}_{\hat{x} \hat{y}} ≡ \sqrt{{( x - {x}^{′} )}^{2} + {( y - {y}^{′} )}^{2}} , {dI}^{′} = {J}_{s} {dz}^{′} , dI = {J}_{s} dz$$

The cumulative force ΔF_{\hat{z}L} applied by all the current loops on the right side on one single current loop L on the left side (see FIG. 7) is given by

$$Δ {F}_{\hat{z} , L} = {\int }_{h}^{h + a} Δ {F}_{\hat{z}} {dz}^{′} = - \frac{μ {J}_{s}^{2} dz}{4 π} {\int }_{h}^{h + a} ( {\int }_{L} {\int }_{{L}^{′}}^{ } \frac{( \hat{d l} \cdot {\hat{d l}}^{′} ) ( z - {z}^{′} )}{{[ {R}_{\hat{x} \hat{y}}^{2} + {( z - {z}^{′} )}^{2} ]}^{3 / 2}} ) {dz}^{′}$$

The total force F_{\hat{z}}(h) acting on the magnet located at the origin is the sum of all the forces on its loops

$${F}_{\hat{z}} ( h ) = {\int }_{0}^{a} Δ {F}_{\hat{z} , L} dz = - \frac{μ {J}_{s}^{2}}{4 π} {\int }_{0}^{a} [ {\int }_{h}^{h + a} ( {\int }_{L} {\int }_{{L}^{′}}^{ } \frac{( \hat{d l} \cdot {\hat{d l}}^{′} ) ( z - {z}^{′} )}{{[ {R}_{\hat{x} \hat{y}}^{2} + {( z - {z}^{′} )}^{2} ]}^{3 / 2}} {dz}^{′} ) dz ]$$

Changing the order of integration we obtain

$${F}_{\hat{z}} ( h ) = - \frac{μ {J}_{s}^{2}}{4 π} {\int }_{L} {\int }_{{L}^{′}}^{ } [ {\int }_{0}^{a} ( {\int }_{h}^{h + a} \frac{( z - {z}^{′} )}{{[ {R}_{\hat{x} \hat{y}}^{2} + {( z - {z}^{′} )}^{2} ]}^{3 / 2}} {dz}^{′} ) dz ] ( \hat{d l} \cdot {\hat{d l}}^{′} )$$

Noting that R_{\hat{x}ŷ}² is independent from z and z′, and therefore is constant when integrating with respect to dz and dz′, the inner integrals can be computed analytically, and yield

$${\int }_{0}^{a} ( {\int }_{h}^{h + a} \frac{( z - {z}^{′} )}{{[ {R}_{\hat{x} \hat{y}}^{2} + {( z - {z}^{′} )}^{2} ]}^{3 / 2}} {dz}^{′} ) dz = ln \{ \frac{[ ( ɛ - A ) + \sqrt{1 + {( ɛ - A )}^{2}} ] [ ( ɛ + A ) + \sqrt{1 + {( ɛ + A )}^{2}} ]}{{( ɛ + \sqrt{1 + ɛ} )}^{2}} \}$$

where we used

$$A = \frac{a}{{R}_{\hat{x} \hat{y}}} , and ɛ = \frac{h}{{R}_{\hat{x} \hat{y}}} .$$

Since R_{\hat{x}ŷ}≧d, then if h²<<d²≦R_{\hat{x}ŷ}² (for instance

$$h < \frac{d}{3} )$$

then

$$\frac{{h}^{2}}{{R}_{\hat{x} \hat{y}}^{2}} = {ɛ}^{2} << 1 ,$$

and we may expand the last expression in a first-order Taylor series as follows

$${\int }_{0}^{a} ( {\int }_{h}^{h + a} \frac{( z - {z}^{′} )}{{[ {R}_{\hat{x} \hat{y}}^{2} + {( z - {z}^{′} )}^{2} ]}^{3 / 2}} {dz}^{′} ) dz = 2 \frac{1 - \sqrt{1 + {A}^{2}}}{\sqrt{1 + {A}^{2}}} ɛ + O ( {ɛ}^{3} ) \approx 2 \frac{1 - \sqrt{1 + {a}^{2} / {R}_{\hat{x} \hat{y}}^{2}}}{\sqrt{1 + {a}^{2} / {R}_{\hat{x} \hat{y}}^{2}}} \cdot \frac{h}{{R}_{\hat{x} \hat{y}}} = g ( x , {x}^{′} , y , {y}^{′} ) \cdot h$$

Since {square root over (1+a²/R_{\hat{x}ŷ}²)}>1, it follows that the function g(x,x′,y,y′) is some negative function of x,x′,y,y′, namely g(x,x′,y,y′)=|g(x,x′,y,y′)|. Therefore, recalling that the sign of the double integral over x,x′,y,y′ is the same as the sign of the integrand, and setting ∫_{L}∫_{L′}|g(x,x′,y,y′)|(d\hat{l}·d\hat{l}′)=K², the total force F_{\hat{z}}(h), acting on the magnet at the origin, due to the offset of the other magnet, has the form

$${F}_{\hat{z}} ( h ) \approx \frac{μ {J}_{s}^{2} h}{4 π} {\int }_{L} {\int }_{{L}^{′}}^{ } \vert g ( x , {x}^{′} , y , {y}^{′} ) \vert ( \hat{d l} \cdot {\hat{d l}}^{′} ) = \frac{{K}^{2} μ {J}_{s}^{2}}{4 π} h , {h}^{2} << {d}^{ 2}$$

where K is some proportionality constant. Finally, recalling that M=Jₛ is the net magnetization per unit volume in the \hat{z} direction, and referring to FIG. 5, the force acting on the left magnet is

$${F}_{\hat{z}} ( h ) = \frac{{K}^{2} μ {M}^{2}}{4 π} h , {h}^{2} << {d}^{ 2}$$

Thus, for any offset h<d/3, the force transferred by the clutch is directly proportional to the offset h and to the square magnetization per unit volume. Moreover, the force is in the direction of the offset itself.

All the above description has been provided for the purpose of illustration and is not meant to limit the invention in any way. The computations shown above are provided as an aid in understanding the invention, and should not be construed as intending to limit the invention in any way.

1. An apparatus, comprising:
a) two concentric rings;
b) an equal number of magnets connected to the inner ring and to the outer ring; and
c) an opposite orientation of the poles of each couple of facing magnets, wherein one magnet is placed on the inner ring, and its facing magnet is placed on the outer ring;
wherein the first of said two concentric rings is rotatable around an axis by the application of a force not applied by the second ring, and wherein when said first concentric ring rotates, the second ring rotates as well by the action of magnetic forces.

2. Apparatus according to claim 1, wherein the rings are flat ring-shaped plates.

3. Apparatus according to claim 1, wherein each couple of facing magnets are of the same size.

4. Apparatus according to claim 1, wherein the magnetic strengths of two facing magnets are essentially the same.

5. Apparatus according to claim 1, wherein each of the magnets in the inner ring has a facing magnet in the outer ring.

6. Apparatus according to claim 1, wherein the connecting means connect one of the rings to an external system.

7. Apparatus according to claim 6, wherein the ring which is not connected to the external system is driven by the rotation of the ring that is connected to the external system.

8. Apparatus according to claim 7, wherein the driven ring is forced to move because of the magnetic force between two coupled magnets.

9. Apparatus according to claim 1, wherein the distances between the components of the apparatus are consistent with the desired forces.

10. Apparatus according to claim 1, wherein the distance between two adjacent magnets on the ring is not the same as the distance between two other adjacent magnets on the same ring.

11. A method for coupling two rings, comprising providing two concentric rings, an equal number of magnets connected to the inner ring and to the outer ring, and an opposite orientation of the poles of each couple of facing magnets, wherein one magnet is placed on the inner ring, and its facing magnet is placed on the outer ring, wherein the first of said two concentric rings is rotatable around an axis by the application of a force not applied by the second ring, and wherein when said first concentric ring rotates, the second ring rotates as well by the action of magnetic forces.
